(19) United States
(12) Patent Application Publication
(10) Pub. No.: US 2002/0011590 A1
(43) Pub. Date: Jan. 31, 2002

(54) Photovoltaic conversion device for thermophotovoltaic power generation apparatus

(76) Inventor: Tomonori Nagashima, Susono-shi (JP)

Correspondence Address: Finnegan, Henderson , Farabow, Garrett & Dunner, L.L.P., 1300 I Street, N.W., Washington, DC, 20005-3315, US

(21) Appl. No.: 09/822,248

(22) Filed: Apr. 2, 2001

(30) Foreign Application Priority Data
Apr. 3, 2000 (JP) 2000-105408

(51) Int. Cl. H01B 1/00; H01B 1/02; H01C 1/00

(52) U.S. Cl. 252/500; 252/512

(57) ABSTRACT

A photovoltaic conversion device having a device structure which enables recombination loss of carriers at the surface to be reduced greatly and which thereby permits Ge to be used as the material suitable for TPV power generation application, and permits a back-face electrode type to be adopted as the electrode structure. This photovoltaic conversion device is comprised of a Ge substrate, a p-type semiconductor layer and a n-type semiconductor layer provided independently of each other on the back-face of the Ge substrate, a positive electrode and a negative electrode provided on the back-face side of the Ge substrate and connected to the p-type semiconductor layer and n-type semiconductor layer, respectively, and a protective film provided on the front face side of the Ge substrate. Hydrogen or halogen is contained in the interface between the Ge substrate and the protective film, or a semiconductor layer with impurity concentration higher than the Ge substrate is provided between the Ge substrate and the protective film.

### BACKGROUND OF THE INVENTION

1. Field of the Invention

The present invention relates to a photovoltaic conversion device suitable for use in a thermophotovoltaic power generation apparatus that converts radiation, from a light emitter heated by a heat source, into electric power by means of the photovoltaic conversion device.

2. Description of the Related Art

As a technology for obtaining electric energy directly from fossil fuel or combustible gas, thermophotovoltaic power generation (TPV power generation), that is, power generation by means of thermophotovoltaic energy conversion, has been attracting wide-spread attention. TPV power generation generates electric power by supplying combustion heat from a heat source to a light emitter (radiator, emitter), and by irradiating a photovoltaic conversion device (solar cell) with the light from the light emitter to obtain electric energy. Thus, a TPV power generation apparatus has no moving parts and, therefore, provides a system that is completely free of noise or vibration. As an energy source for the next generation, TPV power generation has distinct advantages in cleanliness and quietness.

A TPV power generation apparatus has been previously disclosed, for example, in Japanese Unexamined Patent Publication No. 63-316486, in which a thermophotovoltaic power generation apparatus comprising a light emitter fabricated from a porous solid, heating means for heating the light emitter by causing exhaust gas from combustion to flow through the light emitter, and a photovoltaic device for converting radiant energy, from the light emitter, into electric energy, is disclosed.

In TPV power generation, infrared radiation from an emitter at temperatures in the range 1000-1700° C. is utilized. In order to convert radiant energy radiated from the light emitter at wavelength of 1.4-1.7 μm into electric energy, it is necessary to employ a photovoltaic conversion device that is fabricated from material having a small band gap energy (Eg). Si (silicon), which is the most typical semiconductor material, cannot be used since it can convert radiation only at wavelength not greater than 1.1 μm into electric energy.

Thus, materials that have energy band gap energy (Eg) of 0.5-0.7 eV are suitable for a photovoltaic conversion device in a TPV thermophotovoltaic power generation apparatus. Typical materials include, for example, GaSb (gallium antimony, Eg=0.72 eV), InGaAs (indium gallium arsenide, Eg=0.60 eV), Ge (germanium, Eg=0.66 ev), and the like.

In order to increase the efficiency of energy conversion of TPV power generation and to reduce the number of expensive photovoltaic conversion devices used and thereby to reduce cost, a possible solution is to increase the intensity of the light emitted from by light emitter. If, for example, light intensity is increased by a factor of 100, the number of the photovoltaic conversion devices used can be reduced to 1/100, resulting in large reduction in cost as well as considerable improvement of energy conversion efficiency.

In this case, however, since the magnitude of generated electric current is increased, the area of the electrode on the front face side of the conventional photovoltaic conversion device needs to be increased in order to reduce resistive loss. An increase in the electrode area on the front face side of the photovoltaic conversion device, however, would reduce the amount of light incident on the photovoltaic conversion device, and this hinders full utilization of the increase of light intensity.

On the other hand, there is another electrode structure called a back-face electrode type which has no electrode on the front face side and which is utilized in a light-collecting type power generation system. The back-face electrode type is, however, a viable choice only for indirect transition type materials in which the diffusion distance of carriers is large, and in practice only for Si. An indirect transition type material that has small energy band gap includes Ge (germanium). In Ge, however, carrier life time is short compared to Si and recombination loss of carriers at the surface is large. Thus, a photovoltaic conversion device which uses Ge as the substrate material and employs a back-face electrode type as the electrode structure has not been put into practical use.

### SUMMARY OF THE INVENTION

It is an object of the present invention to resolve above-described problem and to provide a photovoltaic conversion device which is suitable for use in TPV power generation and which has configuration that greatly reduces recombination loss of carriers at the surface and thus enables Ge to be used as the substrate material and back-face electrode type to be employed as the electrode structure.

To attain the above object, according to a first aspect of the present invention, a photovoltaic conversion device is provided which is suitable for use in a thermophotovoltaic power generation apparatus that converts radiation from a light emitter heated by a heat source into electric power by means of the photovoltaic conversion device, and which is comprised of a Ge substrate, a p-type semiconductor layer and an n-type semiconductor layer provided independently on the back-face side of the Ge substrate, positive and negative electrodes provided on the back-face side of the Ge substrate and connected, respectively, to the p-type and the n-type semiconductor layers, and a protective film provided on the front face side of the Ge substrate.

According to a second aspect of the present invention, a photovoltaic conversion device according to the above described first aspect is provided, wherein hydrogen or halogen is contained in the interface between the Ge substrate and the protective film.

According to a third aspect of the present invention, a photovoltaic conversion device according to the above described first aspect is provided, wherein a semiconductor layer with an impurity concentration higher than the Ge substrate is provided between the Ge substrate and the protective film.

Further, in order to attain the above object, according to a fourth aspect of the present invention, a photovoltaic conversion device is provided which is suitable for use in a thermophotovoltaic power generation apparatus that converts radiation from a light emitter heated by a heat source into electric power by means of the photovoltaic conversion device, and which is comprised of a Ge layer, a p-type semiconductor layer and a n-type semiconductor layer provided independently of each other on the back-face of the Ge layer, positive and negative electrodes provided on the back-face side of the Ge layer and connected to the p-type and the n-type semiconductor layers, respectively, an Si layer provided on the front face side of the Ge layer, and an SiO₂ film provided on the front face side of the Si layer.

According to a fifth aspect of the present invention, a photovoltaic conversion device, according to the above described fourth aspect, is provided wherein hydrogen or halogen is contained in the interface between the Si layer and the SiO₂ film.

According to a sixth aspect of the present invention, a photovoltaic conversion device according to the above described fourth aspect is provided, wherein a semiconductor layer with an impurity concentration higher than the Si layer is provided between the Si layer and the SiO₂ film, and a semiconductor layer with impurity concentration higher than the Ge layer is provided between the Ge layer and the Si layer.

According to a seventh aspect of the present invention, a photovoltaic conversion device according to the fourth aspect as described above is provided, wherein a mixed layer of Ge and Si is provided between the Ge layer and the Si layer.

### BRIEF DESCRIPTION OF THE DRAWINGS

Further features and advantages of the present invention will be apparent from the following description with reference to the accompanying drawings, in which:

FIG. 1 is a cross sectional view showing a photovoltaic conversion device according to a first embodiment of the present invention;

FIG. 2 is a cross sectional view showing a photovoltaic conversion device according to a second embodiment of the present invention;

FIG. 3 is a cross sectional view showing a photovoltaic conversion device according to a third embodiment of the present invention;

FIG. 4 is a cross sectional view showing a photovoltaic conversion device according to a fourth embodiment of the present invention;

FIG. 5 is a cross sectional view showing a photovoltaic conversion device according to a fifth embodiment of the present invention;

FIG. 6 is a cross sectional view showing a photovoltaic conversion device according to a sixth embodiment of the present invention;

FIG. 7 is a cross sectional view showing a photovoltaic conversion device according to a seventh embodiment of the present invention;

FIG. 8 is a cross sectional view showing a photovoltaic conversion device according to an eighth embodiment of the present invention;

FIG. 9 is a cross sectional view showing a photovoltaic conversion device according to a ninth embodiment of the present invention;

FIG. 10 is a cross sectional view showing a photovoltaic conversion device according to a tenth embodiment of the present invention;

FIG. 11 is a cross sectional view showing a photovoltaic conversion device according to an eleventh embodiment of the present invention; and

FIG. 12 is a cross sectional view showing a photovoltaic conversion device according to a twelfth embodiment of the present invention.

### DESCRIPTION OF THE PREFERRED EMBODIMENTS

The present invention will now be described with reference to drawings showing embodiments thereof.

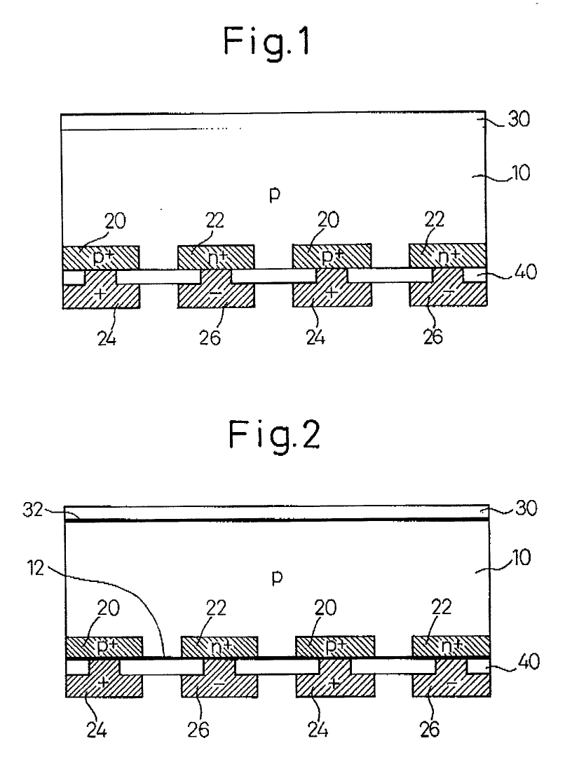

FIG. 1 is a cross sectional view showing a photovoltaic conversion device according to a first embodiment of the present invention. In the photovoltaic conversion device, Ge (germanium, Eg=0.66 eV), a semiconductor material having small energy band gap (Eg), is used as a substrate 10. On the back-face of the Ge substrate 10, a p⁺-layer 20 as a p-type semiconductor layer and a n⁺-layer 22 as a n-type semiconductor layer are formed alternately and independently of each other to collect carriers. On the back-face side of the Ge substrate 10, a positive electrode 24 connected to the p⁺-layer 20 and a negative electrode 26 connected to the n⁺-layer 22 are provided to realize a back-face electrode type structure. A protective film 30 is provided on the front face side of the Ge substrate 10 in order to decrease the number of surface defects and thereby to decrease annihilation of carriers at the surface. Similarly, a protective film 40 is provided on the back-face side of the Ge substrate 10 except where the semiconductor layers 20 and 22 are connected to electrodes 24 and 26, respectively.

The structure of the photovoltaic conversion device shown in FIG. 1 will now be described more specifically. The Ge substrate 10 is, for example, 200 μm thick and forms p-type semiconductor with dopant concentration of 3×10¹⁵cm⁻³. The p⁺-layer 20 has dopant concentration of 1×10¹⁹cm⁻³ and diffusion depth of 2 μm. Similarly, n⁺-layer 22 has dopant concentration of 1×10¹⁹cm⁻³ and diffusion depth of 2 μm. Material having good insulating and light transmission properties such as SiN, SiO₂, TiO₂, etc is suitable for use as the protective films 30 and 40.

The process of fabrication of such a photovoltaic conversion device will next be described. First, protective films 30 and 40 are formed on front and back-faces of the Ge substrate 10. Then, the portion of the protective film where p⁺-layer 20 and n⁺-layer 22 are to be formed is removed by photolithographic technique. Predetermined p⁺-layer 20 and n⁺-layer 22 are then formed by means of a thermal diffusion method, an ion implantation method, or the like. Finally, electrode patterns 24 and 26 are formed.

In the photovoltaic conversion device shown in FIG. 1, light incident from the front face side is absorbed by the Ge substrate 10 thereby to produce electrons and positive holes. The produced electrons diffuse toward the region of n⁺-layer 22, and are collected by the negative electrode 26, while the produced positive holes diffuse toward the region of p⁺-layer 20, and are collected by the positive electrode 24. Electrons and positive holes produced by absorption of light are separated in this manner to produce a photovoltaic electromotive force.

The photovoltaic conversion device having the construction as described above is suited to being used in TPV power generation that converts light from a heated light emitter into electric power, since light is absorbed by Ge with a small energy band gap. The electrode structure of a back-face electrode type adopted in this construction permits the area of the electrode to be increased, and thus permits the resistive loss to be kept small. Simultaneously with the adoption of the back-face electrode type as the electrode structure, the protective film 30 is provided on the front face side of the Ge substrate 10 so that number of surface defects is decreased, and capture of carriers by defects and resulting annihilation of carriers produced near the surface is also decreased. Therefore, with the construction as described above, when the intensity of light from the light emitter is increased in a TPV power generation system, it is possible to avoid an increase in resistive loss in the electrodes, and thereby to realize high conversion efficiency.

As discussed above, the number of photovoltaic conversion devices used can be greatly reduced by increasing the light intensity in TPV power generation system, so that a highly efficient system can be realized at low cost. In such a system, the photovoltaic conversion device of the present invention can take advantage of the small energy band gap of Ge to convert infra red radiation from a light emitter efficiently into electric energy.

FIG. 2 is a cross sectional view showing a photovoltaic conversion device according to a second embodiment of the present invention. In FIG. 2, the same elements as in FIG. 1 are denoted by the same reference numerals, and explanations thereof are not repeated. Construction as shown in FIG. 2 differs from that in FIG. 1 in that, in the construction in FIG. 2 as compared to that in FIG. 1, hydrogen or halogen is contained in the interface 32 between the Ge substrate 10 and the protective film 30. Similarly, hydrogen or halogen is also contained in the interface 12 between the Ge substrate 10 and the protective film 40.

A fabrication method for fabricating the photovoltaic conversion device of FIG. 2 will next be described. In a first fabrication method, SiNx (silicon nitride) films are first formed as the protective films 30 and 40 on both faces of Ge substrate 10 by plasma CVD (chemical vapor deposition) method. When forming the SiNx films, hydrogen gas is mixed to form an SiNx: H film containing hydrogen. In subsequent heat treatment, hydrogen atoms are moved to the interface to be combined with the dangling bonds on the surface of the Ge substrate so as to decrease the number of electric defects.

In a second fabrication method, after the protective films are formed, heat treatment is performed in a hydrogen atmosphere to cause hydrogen atoms to be diffused to the interface. The hydrogen atoms are combined, as in the first fabrication method, with the dangling bonds on the surface of the Ge substrate so as to decrease the number of electric defects. In the case of halogen atoms, a process similar to that the first and the second fabrication methods in the case of hydrogen may be employed to distribute halogen atoms in the interface.

With the photovoltaic conversion device constructed as shown in FIG. 2, the number of dangling bonds is decreased as hydrogen or halogen atoms are combined with the dangling bonds. Thus, number of electric defects that capture carriers and deteriorate the performance is decreased and thus, in turn, reduces the recombination loss of carriers, resulting in improved performance, that is, improved photovoltaic conversion efficiency. Thus, efficiency of the TPV power generation apparatus is improved, leading to increased power production.

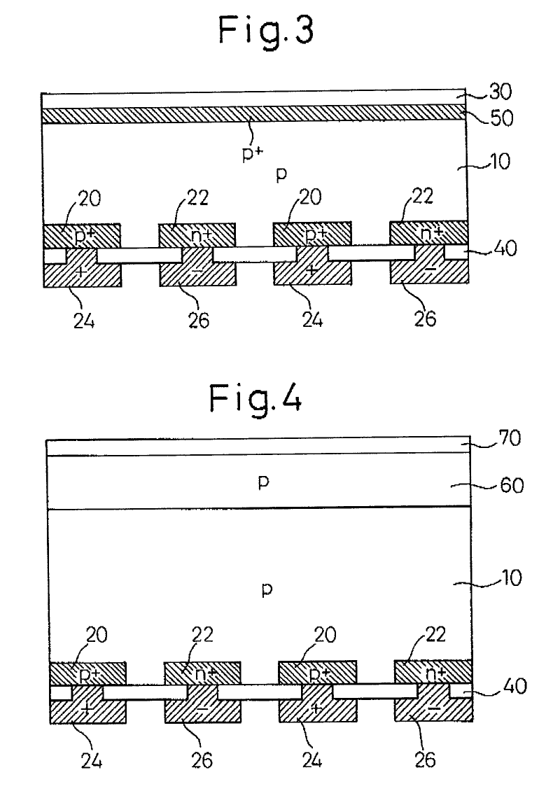

FIG. 3 is a cross sectional view showing a photovoltaic conversion device according to a third embodiment of the present invention. In FIG. 3, the same elements as in FIG. 1 are denoted by the same reference numerals, and an explanation thereof is not repeated. The construction shown in FIG. 3 differs from that in FIG. 1 in that, in the construction in FIG. 3 as compared to that in FIG. 1, a semiconductor layer 50 is formed on the front face of the Ge substrate 10. Thus, a semiconductor layer 50 with impurity concentration higher than the Ge substrate 10 is provided between the Ge substrate 10 and the protective film 30.

The semiconductor layer 50 is formed as p⁺-layer having dopant concentration of 1×10¹⁸cm⁻³ and diffusion depth of 2 μm. A fabrication method for fabricating the photovoltaic conversion device of FIG. 3 will next be described. First, protective films 30 and 40 are formed on the front and back-faces of the Ge substrate 10. Then, the portion of the protective films where the p⁺-layer 20 and n⁺-layer 22 are to be formed is removed by photolithographic technique. Predetermined p⁺-layer 20 and n⁺-layer 22 are then formed by means of a thermal diffusion method, an ion implantation method, or the like. Then, the protective film 30 on the front face side is removed, and a semiconductor layer 50 is formed on the front face side of the Ge substrate 10. The protective film 30 is again formed on the front face side. Finally, electrode patterns 24 and 26 are formed.

In the photovoltaic conversion device having the construction as shown in FIG. 3, the semiconductor layer (p⁺-layer) 50 is a region of higher energy level and therefore greatly reduces the proportion of the carriers (electrons) produced near the surface which move toward the surface where many defects are present. Thus, the number of carriers (electrons) that move toward surface defects and are annihilated there is decreased, leading to a reduction in the recombination loss and an improvement in the performance (photovoltaic conversion efficiency). Therefore, efficiency of the TPV power generation apparatus is improved, leading to an increased power production.

FIG. 4 is a cross sectional view showing a photovoltaic conversion device according to a fourth embodiment of the present invention. Again, in the photovoltaic conversion device, a layer of Ge which is semiconductor material having small energy band gap is used as the Ge substrate 10. On the back-face of the Ge substrate 10, a p⁺-layer 20 as a p-type semiconductor layer and a n⁺-layer 22 as a n-type semiconductor layer are formed alternately and independently of each other to collect carriers. On the back-face side of the Ge substrate 10, a positive electrode 24 connected to the p⁺-layer 20 and a negative electrode 26 connected to the n⁺-layer 22 are provided and thereby realize back-face type electrode structure. A Si layer 60 is provided on the front face side of the Ge substrate 10, and a SiO₂ film 70 is provided on the front face side of the Si layer 60. A protective film 40 is provided on the back-face side of the Ge substrate 10 except where the semiconductor layers 20 and 22 are connected to electrodes 24 and 26, respectively.

The structure of the photovoltaic conversion device shown in FIG. 4 will now be described more specifically. The Ge substrate 10 is, for example, 200 μm thick and forms p-type semiconductor with dopant concentration of 3×10¹⁵cm⁻³ . The p⁺-layer 20 has dopant concentration of 1×10¹⁹cm⁻³ and diffusion depth of 2 μm. Similarly, n⁺-layer 22 has dopant concentration of 1×10¹⁹cm⁻³ and diffusion depth of 2 μm. The Si layer 60 is 5 μm thick and forms p-type semiconductor with dopant concentration of 1×10¹⁵cm⁻³. The SiO₂ film 70 is 110 μnm thick.

A process of fabricating such a photovoltaic conversion device of FIG. 4 will next be described. First, the Si layer 60 is formed on the surface of the Ge substrate 10 by plasma CVD method or the like. Then, the SiO₂ film 70 is formed on the front face side of the Si layer 60. The protective film 40 is then formed on the back-face side of the Ge substrate 10. Next, the portion of the protective film where p⁺-layer 20 and n⁺-layer 22 are to be formed is removed by photolithographic technique. Then, predetermined p⁺-layer 20 and n⁺-layer 22 are formed by means of thermal diffusion method, ion implantation method, or the like. Finally, electrode patterns 24 and 26 are formed.

With the photovoltaic conversion device constructed as shown in FIG. 4, a protective film (SiO₂ film) 70 having fewer interface defects is formed on the front face of Si layer 60. Therefore, recombination loss on the front face side can be reduced to a greater extent than when the protective film is formed directly on the Ge surface. The number of defects present on the Ge surface can be thus decreased using Si layer 60 and SiO₂ film 70. In this manner, this construction can take advantage of the small energy band gap of Ge to convert infra red radiation emitted by a light emitter efficiently into electricity.

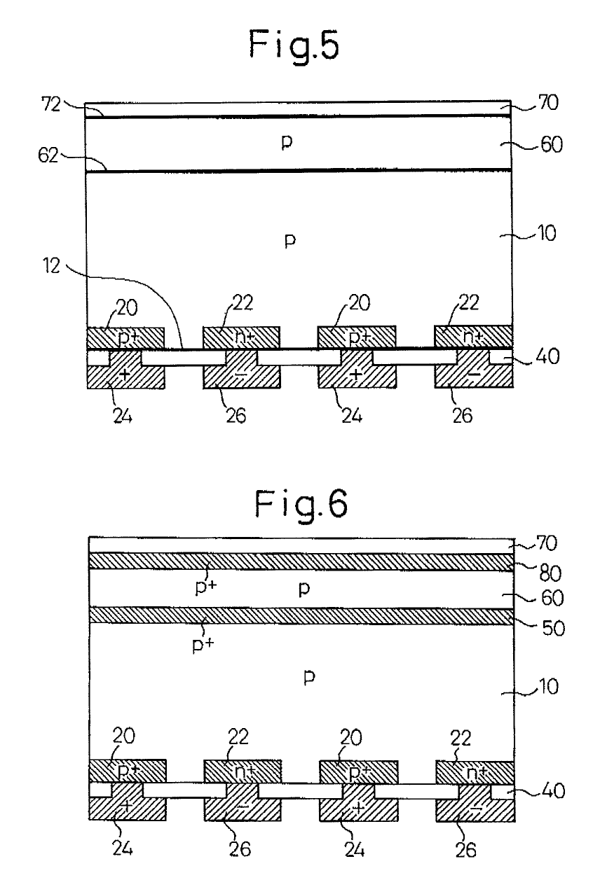

FIG. 5 is a cross sectional view showing a photovoltaic conversion device according to a fifth embodiment of the present invention. In FIG. 5, the same elements as in FIG. 4 are denoted by the same reference numerals, and explanations thereof are not repeated. The construction shown in FIG. 5 differs from that in FIG. 4 in that, in the construction in FIG. 5 as compared to that in FIG. 4, hydrogen or halogen is contained in the interface 72 between the Si layer 60 and the SiO₂ film 70. Similarly, hydrogen or halogen is contained also in the interface 62 between the Ge substrate 10 and the Si layer 60, and in the interface 12 between the Ge substrate 10 and the protective film 40. The same fabrication method as described with reference to FIG. 2 may be employed to cause hydrogen or halogen to be present in this manner, and the presence of hydrogen or halogen provides the same operational effect as that described with reference to FIG. 2.

FIG. 6 is a cross sectional view showing a photovoltaic conversion device according to a sixth embodiment of the present invention. In FIG. 6, the same elements as in FIG. 4 are denoted by the same reference numerals, and explanations thereof are not repeated. The construction as shown in FIG. 6 differs from that in FIG. 4 in that, in the construction in FIG. 6 as compared to that in FIG. 4, a semiconductor layer 80 is formed on the front face of the Si layer 60, and that a semiconductor layer 50 is formed on the front face of the Ge substrate 10. Thus, as shown in FIG. 6, a semiconductor layer 80 having an impurity concentration higher than that of the Si layer 60 is provided between the Si layer 60 and the SiO₂ film 70, and a semiconductor layer 50 having impurity concentration higher than that of the Ge substrate 10 is provided between the Ge substrate 10 and the Si layer 60. These semiconductor layers 50 and 80 may be formed using the same fabrication method as described with reference to FIG. 3, and the presence of these layers provides the same operational effect as described with reference to FIG. 3.

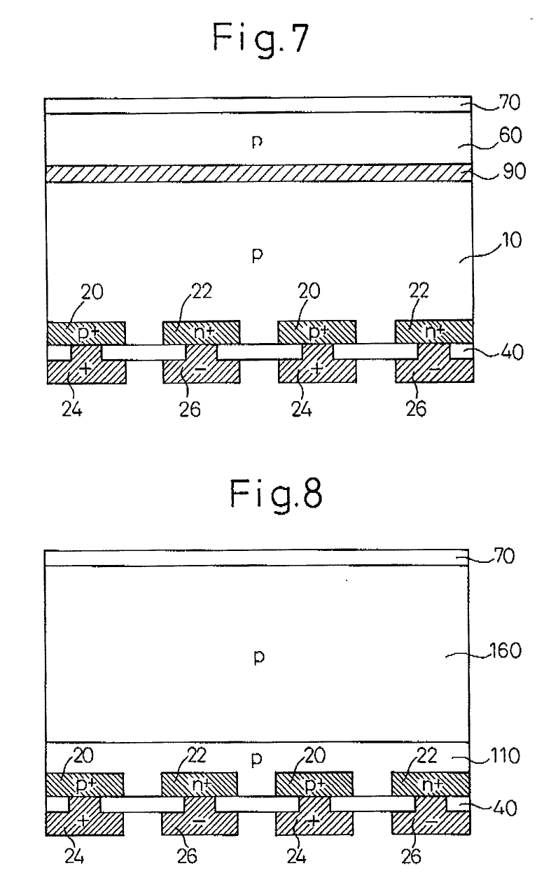

FIG. 7 is a cross sectional view showing a photovoltaic conversion device according to a seventh embodiment of the present invention. In FIG. 7, the same elements as in FIG. 4 are denoted by the same reference numerals, and explanations thereof are not repeated. The construction as shown in FIG. 7 differs from that in FIG. 4 in that, in the construction in FIG. 7 as compared to that in FIG. 4, a mixed layer of Ge and Si, that is, an intermediate layer 90, is provided between the Ge substrate 10 and the Si layer 60.

A fabrication method for fabricating the photovoltaic conversion device of FIG. 7 will next be described. First, a mixed layer 90 of Si and Ge is formed on the surface of the Ge substrate 10 using a plasma CVD method or the like. When forming this layer 90, the mixing ratio of Si and Ge is varied continuously in the intermediate layer 90 by adjusting the proportion of raw material gases for Si and Ge so as to cause Ge to be more abundant near the Ge substrate and Si to be more abundant near the front face. Then, the Si layer 60 is formed on the surface of the intermediate layer by plasma CVD method or the like. A protective film 40 is then formed on the back-face of the Ge substrate 10. Next, the portion of the protective film where p⁺-layer 20 and n⁺-layer 22 are to be formed is removed by photolithographic technique. Then, predetermined p⁺-layer 20 and n⁺-layer 22 are formed by means of a thermal diffusion method, an ion implantation method, or the like. Finally, electrode patterns 24 and 26 are formed.

With the photovoltaic conversion device having the construction as shown in FIG. 7, since the intermediate layer 90 is provided in which mixing ratio of Si and Ge varies continuously, the energy band gap for the region between the Ge substrate 10 and the Si layer 60 varies continuously so that discontinuity of band (knotch or gap) formed in the hetero junction is relaxed to a great extent. Since the discontinuity of band that forms a barrier for the movement of carriers produced in the Si layer 60 toward the Ge substrate 10 is relaxed, recombination loss of carriers is reduced, which results in improvement of the performance (photovoltaic conversion efficiency). Therefore, efficiency of the TPV power generation apparatus is improved, leading to increased power production.

Above described embodiments are based on the Ge substrate. On the other hand, Si substrates are widely used in semiconductor devices, and Si is abundant as a natural resource, and less expensive than Ge. However, as discussed before, Si cannot convert infra red radiation emitted by a light emitter in a TPV system efficiently into electric energy. A photovoltaic conversion device using Si substrate will be described in the following.

FIG. 8 is a cross sectional view showing a photovoltaic conversion device according to a eighth embodiment of the present invention. In the photovoltaic conversion device shown in FIG. 8, a Ge layer 110 is formed on the back-face side of a Si substrate 160 that is a Si layer. On the back-face side of the Ge layer 110, a p⁺-layer 20 as a p-type semiconductor layer and a n⁺-layer 22 as a n-type semiconductor layer are formed alternately and independently of each other to collect carriers. On the back-face side of the Ge layer 110, a positive electrode 24 connected to the p⁺-layer 20 and a negative electrode 26 connected to the n⁺-layer 22 are provided to realize a back-face electrode type structure. A SiO₂ film 70 is provided on the front face side of the Si substrate 160. A protective film 40 is provided on the back-face side of the Ge layer 110 except where the semiconductor layers 20 and 22 are connected, respectively, to electrodes 24 and 26.

The structure of the photovoltaic conversion device shown in FIG. 8 will now be described more specifically, The Si substrate 160 is, for example, 200 μm thick and forms p-type semiconductor with dopant concentration of 1×10¹⁵cm⁻³. The Ge layer 110 is 10 μm thick and forms p-type semiconductor with dopant concentration of 3×10¹⁵cm⁻³. The p⁺-layer 20 has dopant concentration of 1×10¹⁹cm⁻³ and diffusion depth of 2 μm. Similarly, n⁺-layer 22 has dopant concentration of 1×10¹⁹cm⁻³ and diffusion depth of 2 μm. The SiO₂ film 70 is 110 μm thick.

A fabrication method for fabricating the photovoltaic conversion device of FIG. 8 will next be described. First, the SiO₂ film 70 is formed on the front face of the Si substrate 160. Then, the Ge layer 110 is formed on the back-face side of the Si substrate 160 using a plasma CVD method or the like. The protective film 40 is then formed on the back-face of Ge layer 110. Then, the portion of the protective film where p⁺-layer 20 and n⁺-layer 22 are to be formed is removed by means of a photolithographic technique. Then, predetermined p⁺-layer 20 and n⁺-layer 22 are formed by means of a thermal diffusion method, an ion implantation method, or the like. Finally, electrode patterns 24 and 26 are formed.

In the photovoltaic conversion device shown in FIG. 8, the Ge layer 110 is provided on the back-face side of the Si substrate 160 so that infrared radiation can be converted efficiently to electricity. By fabricating the back-face electrode type photovoltaic conversion device so as to include a Ge layer on the back-face side of the Si substrate, it is possible to realize a photovoltaic conversion device, suitable for use in TPV power generation, at low cost.

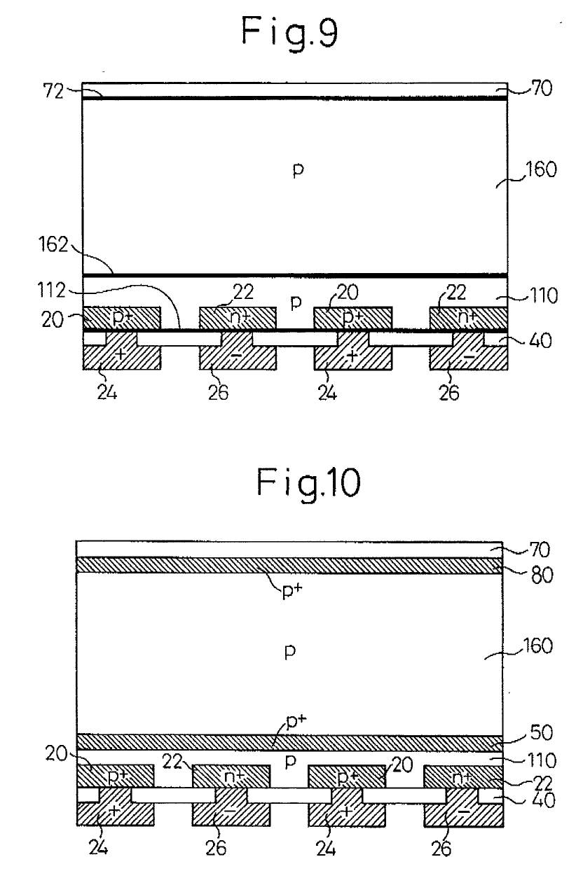

FIG. 9 is a cross sectional view showing a photovoltaic conversion device according to a ninth embodiment of the present invention. In FIG. 9, the same elements as in FIG. 8 are denoted by the same reference numerals, and explanations thereof are not repeated. The construction as shown in FIG. 9 differs from that in FIG. 8 in that, in the construction in FIG. 9 as compared to that in FIG. 8, hydrogen or halogen is contained in the interface 72 between the Si substrate 160 and the SiO₂ film 70. Similarly, hydrogen or halogen is contained in the interface 162 between the Ge layer 110 and the Si substrate 160 and in the interface 112 between the Ge layer 110 and the protective film 40. The same fabrication method as described with reference to FIG. 2 may be employed to cause hydrogen or halogen to be present in this manner, and the presence of hydrogen or halogen provides the same operational effect as described with reference to FIG. 2.

FIG. 10 is a cross sectional view showing a photovoltaic conversion device according to a tenth embodiment of the present invention. In FIG. 10, the same elements as in FIG. 8 are denoted by the same reference numerals, and explanations thereof are not repeated. The construction as shown in FIG. 10 differs from that in FIG. 8 in that, in the construction in FIG. 10 as compared to that in FIG. 8, a semiconductor layer 80 is formed on the front face of Si substrate 160 and that a semiconductor layer 50 is formed on the front face of the Ge layer 110. Thus, a semiconductor layer 80 that has an impurity concentration higher than Si substrate is provided between the Si substrate 160 and the SiO₂ film 70, and a semiconductor layer 50 that has an impurity concentration higher than the Ge layer 110 is provided between the Ge layer 110 and the Si substrate 160. These semiconductor layers 50 and 80 may be formed using the same fabrication method as described with reference to FIG. 3, and the presence of these layers provides the same operational effect as described with reference to FIG. 3.

FIG. 11 is a cross sectional view showing a photovoltaic conversion device according to an eleventh embodiment of the present invention. In FIG. 11, the same elements as in FIG. 8 are denoted by the same reference numerals, and explanations thereof are not repeated. The construction as shown in FIG. 11 differs from that in FIG. 8 in that, in the construction in FIG. 11 as compared to that in FIG. 8, an intermediate layer 90, that is, a mixed layer of Ge and Si, is provided between the Ge layer 110 and the Si substrate 160. Such an intermediate layer 90 is formed by the same fabrication method as described with reference to FIG. 7, and its presence provides the same operational effect as described with reference to FIG. 7.

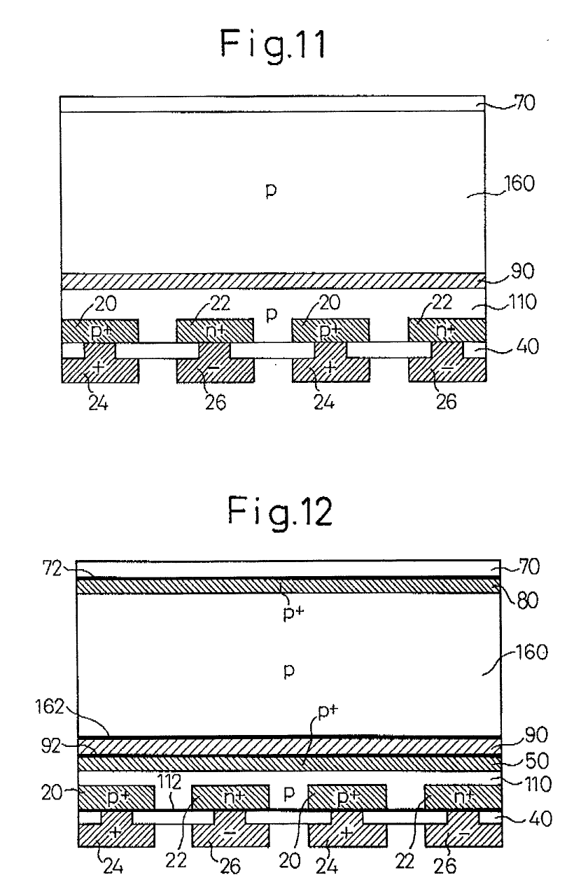

FIG. 12 is a cross sectional view showing a photovoltaic conversion device according to a twelfth embodiment of the present invention. This construction shows the most excellent balance between cost and performance. On the front face side of the Si substrate 160, a p⁺-semiconductor layer 80 and an SiO₂ film 70 are formed. On the back-face side, an Si-Ge intermediate layer 90 is provided, followed by the formation of a Ge-p⁺-semiconductor layer 50 and the Ge layer 110. Then, p⁺-layer 20 and n⁺-layer 22 for collecting carriers as well as electrode patterns 24 and 26, are provided.

As described before, the intermediate layer 90 serves to improve the mobility of carriers. The p⁺-semiconductor layers 80 and 50 that are provided on the front face side of the Si substrate 160 and on the front face side of the Ge layer 110, respectively, serve to prevent carriers from diffusing toward the surface where many defects are present, and being annihilated there, as described before. Hydrogen or halogen is contained in each of the interfaces 112, 92, 162, and 72, and serves to decrease the number of defects in the interfaces, as described before, thereby leading to a reduction in the recombination loss.

By adopting the construction as described above, a back-face electrode type photovoltaic conversion device can be formed. With such a photovoltaic conversion device, energy conversion efficiency in a TPV power generation apparatus using a light emitter with high photon flux can be improved at low cost.

As has been discussed, according to the present invention, a photovoltaic conversion device is provided which uses Ge that is suited to the TPV power generation application as main material, and employs back-face electrode type as the electrode structure, and which has the device construction that enables the recombination loss of carriers at the surface to be reduced greatly.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A photovoltaic conversion device suitable for use in a thermophotovoltaic power generation apparatus that converts radiation from a light emitter heated by a heat source into electric energy, said photovoltaic conversion device comprising:
a Ge substrate;
a p-type semiconductor layer and a n-type semiconductor layer provided independently of each other on the back-face of said Ge substrate;
a positive electrode and a negative electrode provided on the back-face side of said Ge substrate and connected to said p-type semiconductor layer and n-type semiconductor layer, respectively; and
a protective film provided on the front face side of said Ge substrate.

2. A photovoltaic conversion device according to claim 1, wherein hydrogen or halogen is contained in the interface between said Ge substrate and said protective film.

3. A photovoltaic conversion device according to claim 1, wherein a semiconductor layer with impurity concentration higher than said Ge substrate is provided between said Ge substrate and said protective film.

4. A photovoltaic conversion device suitable for use in a thermophotovoltaic power generation apparatus that converts radiation from a light emitter heated by a heat source into electric energy, said photovoltaic conversion device comprising:
a Ge substrate;
a p-type semiconductor layer and a n-type semiconductor layer provided independently of each other on the back-face of said Ge substrate;
a positive electrode and a negative electrode provided on the back-face side of said Ge substrate and connected to said p-type semiconductor layer and n-type semiconductor layer, respectively;
an Si layer provided on the front face side of said Ge layer; and
an SiO₂ film provided on the front face side of said Si layer.

5. A photovoltaic conversion device according to claim 4, wherein hydrogen or halogen is contained in the interface between said Si layer and said SiO₂ film.

6. A photovoltaic conversion device according to claim 4, wherein a semiconductor layer with impurity concentration higher than said Si layer is provided between said Si layer and said SiO₂ film, or a semiconductor layer with impurity concentration higher than said Ge layer is provided between said Ge layer and said Si layer.

7. A photovoltaic conversion device according to claim 4, wherein a mixed layer of Ge and Si is provided between said Ge layer and said Si layer.
